(19) United States
(12) Patent Application Publication
(10) Pub. No.: US 2025/0385975 A1
(43) Pub. Date: Dec. 18, 2025

(54) IMAGE FORMING APPARATUS AND CONTROL METHOD

(71) Applicant: CANON KABUSHIKI KAISHA, Tokyo (JP)

(72) Inventor: KOHEI SHIOZAKI, Kanagawa (JP)

(21) Appl. No.: 19/231,209

(22) Filed: Jun. 6, 2025

(30) Foreign Application Priority Data
Jun. 14, 2024 (JP) 2024-096379

(51) Int. Cl. H04N 1/00; G06T 7/00

(52) U.S. Cl. CPC H04N 1/00039; G06T 7/0004; H04N 1/00015; H04N 1/00029; H04N 1/00058; H04N 1/00074; H04N 1/00344; G06T 2207/10008; G06T 2207/20104; G06T 2207/30144

(57) ABSTRACT

An image forming apparatus, including an operation panel having a display screen, displays an image obtained by scanning a print product, receives information about a position in the image specified by a user via the display screen, identifies at least one image defect candidate region obtained through analysis of the image as a region of an image defect corresponding to the position specified by the user, based on image defect candidate region position information, image defect candidate region confidence, and information about the position specified by the user, and displays information corresponding to the at least one image defect candidate region identified on the display screen.

### BACKGROUND

### Technical Field

The present disclosure relates to a technique for easily identifying regions of defective positions in an image specified by a user.

### Description of the Related Art

A defective or stained part of an image forming apparatus may cause a printing defect on a print product printed by the image forming apparatus. In this case, a scan image obtained by scanning the print product also includes a defect (hereinafter, referred to as an image defect). There has been considered an image diagnostic service for analyzing a scan image including an image defect to identify a defective part causing the image defect.

For example, Japanese Patent Application Laid-Open No. 2003-043867 discusses a technique in which, if a defect occurs in a print product, a multifunction peripheral (MFP) performs test printing, scans the test print product, and transmits the scan image to a server. The server compares the received scan image with a normal character pattern used for test printing and identifies the defect type and a recovery method.

If image diagnosis is performed through test printing as in Japanese Patent Application Laid-Open No. 2003-043867, a normal pattern used for test printing can be used as a correct answer image. This makes it possible to determine the defect type by comparing the scan image of the print product to the correct answer image. However, the conventional technique requires procedures for printing a test pattern, which is troublesome.

Thus, an image diagnostic mechanism is considered. If the user of the image forming apparatus finds a defect in a print product obtained by performing printing based on print data prepared by the user, image diagnosis is performed by using the print product as it is without using a test pattern. Japanese Patent Application Laid-Open No. 2015-119269 discusses a technique for specifying a region in image data, and, based on image feature information included in the specified region, estimating the cause of an image defect included in the specified region.

Meanwhile, it is difficult for a user to correctly specify an image defect region on a screen when image defects include small point- and line-like defects.

### SUMMARY

According to an aspect of the present disclosure, an image forming apparatus includes an operation panel having a display screen, one or more memories storing one or more instructions, and one or more processors that, upon execution of the stored one or more instructions, cause the image forming apparatus to display an image obtained by scanning a print product on the display screen of the operation panel, receive information about a position in the image specified by a user via the display screen of the operation panel, identify at least one image defect candidate region obtained through analysis of the image as a region of an image defect corresponding to the position specified by the user, based on image defect candidate region position information, image defect candidate region confidence, and information about the position specified by the user, and display information corresponding to the at least one image defect candidate region identified on the display screen of the operation panel.

Further features of the present disclosure will become apparent from the following description of exemplary embodiments with reference to the attached drawings.

### BRIEF DESCRIPTION OF THE DRAWINGS

FIG. 1 illustrates a system configuration according to a first exemplary embodiment.

FIG. 2 illustrates a hardware configuration of an image forming apparatus according to an exemplary embodiment.

FIG. 3 is a flowchart illustrating operation of the image forming apparatus according to the first exemplary embodiment.

FIGS. 4A and 4B illustrate an example of user image data before and after image diagnosis.

FIG. 5 illustrates an example of a result of image defect detection.

FIG. 6 illustrates an example of an image defect position input screen.

FIG. 7 is a flowchart illustrating identification of image defect candidates according to the first exemplary embodiment.

FIG. 8 illustrates an example of identification of image defect candidates.

FIG. 9 illustrates an example of a result of confidence distance calculation.

FIGS. 10A and 10B illustrate examples of image defect candidate check screens.

FIG. 11 illustrates an example of a detection image defect check screen.

FIGS. 12A to 12C illustrate examples of image diagnosis result screens.

FIG. 13 illustrates an example of a user print product having streaks of image defects resulting from an identical cause.

FIG. 14 is a flowchart illustrating identification of image defect candidates according to a second exemplary embodiment.

FIG. 15 illustrates identification of image defect candidates according to the second exemplary embodiment.

### DESCRIPTION OF THE EMBODIMENTS

Exemplary embodiments will be described below with reference to the accompanying drawings. The following exemplary embodiments are not intended to limit the scope of the appended claims to what has been expressly disclosed. Although a plurality of features is described in the exemplary embodiments, not all features of the plurality of features are indispensable to the present disclosure, and the plurality of features may be combined in any manner. To the extent identical or similar components are assigned the same reference numerals in the accompanying drawings, duplicated descriptions thereof will be omitted.

In the following descriptions, a print product printed by an image forming apparatus based on user print data (print data based on a document or image created by a user) is referred to as a user print product, and an image obtained by scanning a user print product via a scanner is referred to as user image data.

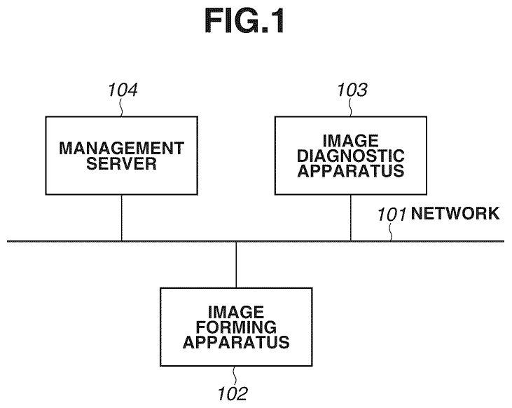

A first exemplary embodiment of the present disclosure will be described. FIG. 1 illustrates a system configuration according to the first exemplary embodiment, including an image forming apparatus 102, an image diagnostic apparatus 103, a management server 104 of a vendor, and a network 101. The image forming apparatus 102 is, for example, a digital multifunction peripheral (MFP) having printing and scanning functions. The image diagnostic apparatus 103 performs image diagnosis on image data transmitted from the image forming apparatus 102 via the network 101 and transmits a result of image defect detection to the image forming apparatus 102. The image diagnostic apparatus 103 may be a server apparatus connected to the network 101, a virtual server on a cloud system, or included in the image forming apparatus 102.

The management server 104 of the vendor manages information about customers of the vendor's services, and information such as the model number and defective parts of the image forming apparatus 102 transmitted from the image forming apparatus 102 via the network 101.

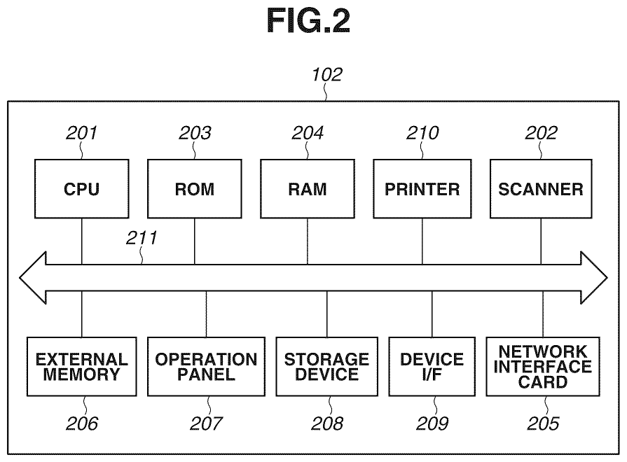

The hardware configuration of the image forming apparatus 102 according to exemplary embodiments of the present disclosure will be described below with reference to FIG. 2. The image forming apparatus 102 includes a Central Processing Unit (CPU) 201, a Read Only Memory (ROM) 203, a Random Access Memory (RAM) 204, a network interface card 205, an external memory 206, an operation panel 207, a storage device 208, a device interface 209, a printer 210, and a scanner 202. These components are connected via a system bus 211.

The CPU (processor) 201 centrally controls access to various devices connected to the system bus 211. The CPU 201 reads control programs and resource data (resource information) stored in the ROM 203 or the external memory 206 into the RAM 204 and then executes the control programs to function as processing units for executing each process of the image forming apparatus 102 (described below).

The ROM 203 stores programs such as basic input/output (I/O) programs, programs for receiving user instructions for image diagnosis, and various data. The RAM 204 functions as the main memory of the CPU 201 and a working area and is configured to allow memory capacity expansion through an optional RAM which is connected to an extension port (not illustrated).

The network interface card 205 is an interface for communicating with an external apparatus. The image forming apparatus 102 exchanges data with external apparatuses such as the image diagnostic apparatus 103 and the management server 104 via the network interface card 205. The operation panel 207 includes a liquid crystal touch panel for displaying operation screens and receiving user operation instructions via the operation screens. The operation panel 207 may include not only a liquid crystal touch panel but also physical buttons for setting the operation mode of the image forming apparatus 102, setting the number of prints or copies, or issuing a start instruction.

The storage device 208 is an external storage unit that functions as a large-capacity memory. The device interface 209 is used for connection with an external device connectable via a Universal Serial Bus (USB) port and the like. The printer 210 prints print data converted into Page Description Language (PDL) and image data converted from a Portable Document Format (PDF) file on a sheet. The printer 210 uses a known print function. Examples of applicable printing methods include the electrophotographic method (laser beam method), inkjet method, and sublimation (thermal-transfer) method.

The scanner 202 uses a known image read function. For example, the scanner 202 optically scans a paper document (print product) placed on a transparent document positioning plate and converts the scanned image into image data. The scanner 202 may have functions of successively reading a plurality of paper document sheets placed on an Automatic Document Feeder (ADF) and converting the read image into image data. The image data (scan image) is temporarily stored in a storage area such as the storage device 208, a RAM 204, or a cache memory. In a case where image diagnosis is performed, the CPU 201 of the image forming apparatus 102 transmits a scan image to the image diagnostic apparatus 103 via the network 101.

The image diagnostic apparatus 103 analyzes a scan image to detect an image defect position candidate in the scan image and detects the type and position of the image defect included in the scan image. The image diagnostic apparatus 103 can also execute image diagnostic processing to identify a defective part that has caused the image defect, based on the identified position and type of the image defect. In the present exemplary embodiment, an image defect position candidate is detected from a scan image without comparing the scan image to a correct answer image. Thus, depending on the details of a print product, a normally printed position may be erroneously detected as an image defect position candidate.

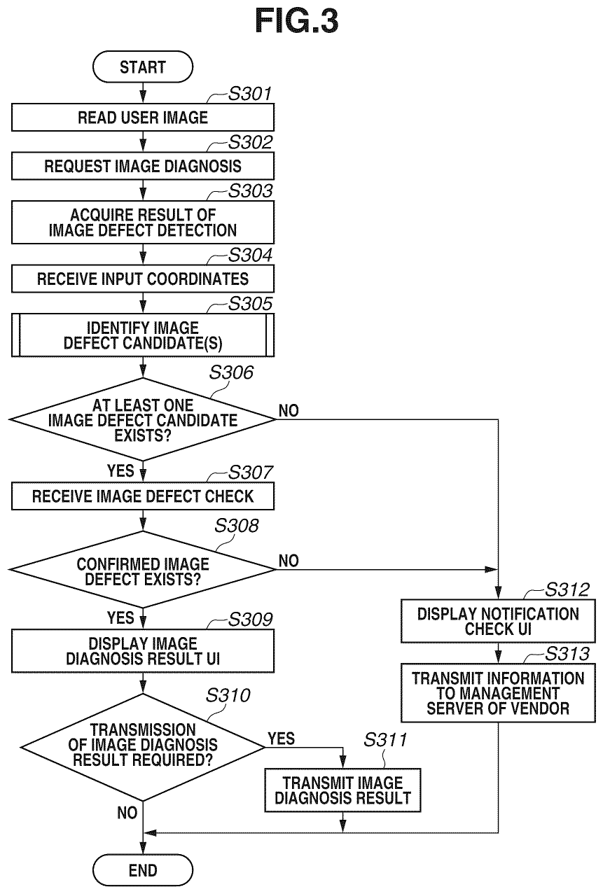

FIG. 3 is a flowchart illustrating a process of operation control of the image forming apparatus 102 according to the present exemplary embodiment. According to the present exemplary embodiment, if an image defect occurs in a print product printed by the printer 210 of the image forming apparatus 102, the image forming apparatus 102 uses, for image diagnosis, a scan image that is obtained by reading the print product via the scanner 202 of the image forming apparatus 102. When image diagnosis is selected from a menu (not illustrated) displayed on the operation panel 207, and an image diagnosis start instruction is received from an image diagnosis execution screen, the CPU 201 of the image forming apparatus 102 starts processing from step S301. The user sets the print product having an image defect to the scanner 202 as a print product to be subjected to image diagnosis and issues an image diagnosis start instruction.

In step S301, the CPU 201 reads the user print product to be subjected to image diagnosis via the scanner 202 to acquire user image data 401. The CPU 201 stores the user image data 401 in the storage device 208.

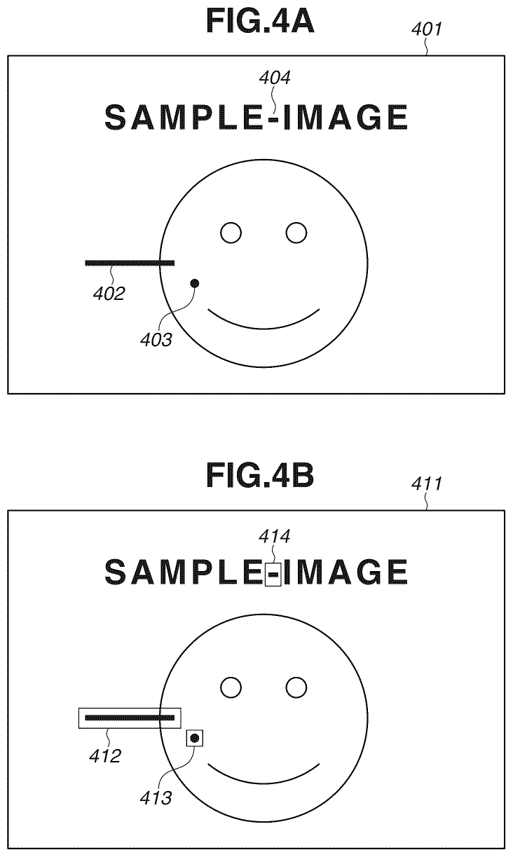

FIG. 4A illustrates an example of the user image data 401 to be subjected to image diagnosis obtained through the conversion performed by the CPU 201 in step S301. An image defect 402 is a line-like image defect occurring on the user print product generated by the image forming apparatus 102 (examples of line-like image defects include black lines and lines of other colors, which are not included in the original image content to be printed on the user print product). User image elements 403 and 404 are originally included as image elements to be printed on the user print product and are examples of elements having similar shapes to point-like and line-like image defects. Referring to the example illustrated in FIG. 4A, the user image element 403 is a mole on the face of a person, and the user image element 404 is a hyphen.

In step S302, the CPU 201 transmits the user image data 401 to the image diagnostic apparatus 103 via the network interface card 205 to request that the image diagnostic apparatus 103 perform image diagnosis.

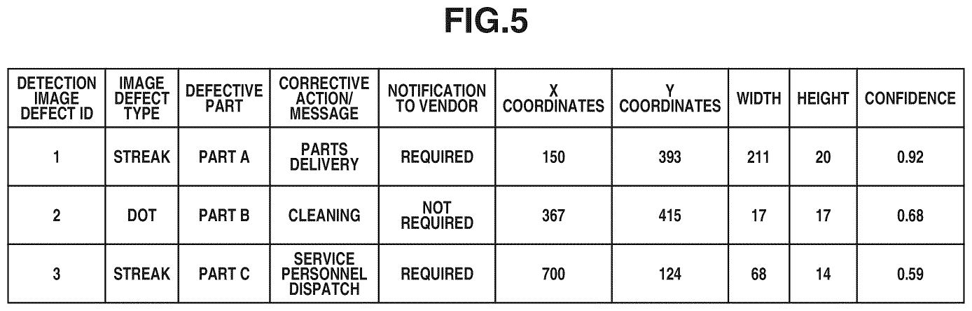

In step S303, the CPU 201 acquires the result of image defect detection (e.g., detection result data as illustrated in FIG. 5) from the image diagnostic apparatus 103 via the network interface card 205. Then, the CPU 201 stores the result of the image defect detection in the storage device 208.

FIG. 5 illustrates tabular format data obtained in step S303, which indicates the result of image defect detection output when the image diagnostic apparatus 103 performs image diagnosis on the user image data 401. In the following descriptions, an image defect candidate detected as a result of image diagnosis on the user image data 401 performed by the image diagnostic apparatus 103 is referred to as a detection image defect. “Detection Image Defect ID” is a unique identifier assigned to each individual detection image defect. “Image Defect Type” indicates the type of the detection image defect, such as a line-like image defect (hereinafter referred to as a streak) or a point-like image defect (hereinafter referred to as a dot). “Defective Part” refers to the part name indicating the defective part determined to be the cause of the image defect by the image diagnostic apparatus 103, based on the type and position of the detection image defect.

“Corrective Action/Message” refers to information about corrective action to be taken for the defective part determined to be the cause of the image defect by the image diagnostic apparatus 103 and information about a message to be notified to the user. “Notification to Vendor” refers to the necessity of notifying the vendor of the defective part and corrective action determined by the image diagnostic apparatus 103. “X Coordinates” and “Y Coordinates” indicate the coordinates (pixel values) of the upper left corner of the detection image defect. “Height” and “Width” indicate the height and width (pixel values) of the detection image defect. “Confidence” is represented by a numerical value from 0 to 1, inclusive, and refers to the likelihood that the detection result for a detection image defect is an image defect. A value closer to one indicates a higher probability that the detection result for a detection image defect is an image defect. More specifically, the confidence indicates the degree of certainty that an image defect occurs in the image defect candidate region (the region indicated by the above-described X coordinate, Y coordinate, width, and height) as a result of analyzing the scan image performed by the image diagnostic apparatus 103. Although FIG. 5 illustrates the result of the image defect detection in a tabular format, the data format is not limited to the tabular format.

FIG. 4B illustrates which position in FIG. 4A corresponds to the result of the image defect detection in FIG. 5 obtained in step S303. The bounding boxes 412, 413, and 414 on user image data 411 indicate the positions of the regions detected as image defect candidates by the image diagnostic apparatus 103 as a result of analyzing the user image data 401 (the bounding boxes 412 to 414 correspond to the detection image defect IDs 1 to 3 in FIG. 5, respectively). The bounding box 412 indicates the position of the image defect 402 detected by the image diagnostic apparatus 103. The bounding box 413 indicates the position of the user image element 403 erroneously detected as an image defect by the image diagnostic apparatus 103.

The bounding box 414 indicates the position of the user image element 404 erroneously detected as an image defect by the image diagnostic apparatus 103.

Normally, because the user recognizes the original data printed on a print product, the user can identify the positions where image defects occur when the user views the print product. Thus, in step S304, the CPU 201 displays, on the operation panel 207, a position input screen 601 for the user to specify, on the scanned image, an image defect position determined by the user. The CPU 201 stores the input coordinates input by the user in the storage device 208.

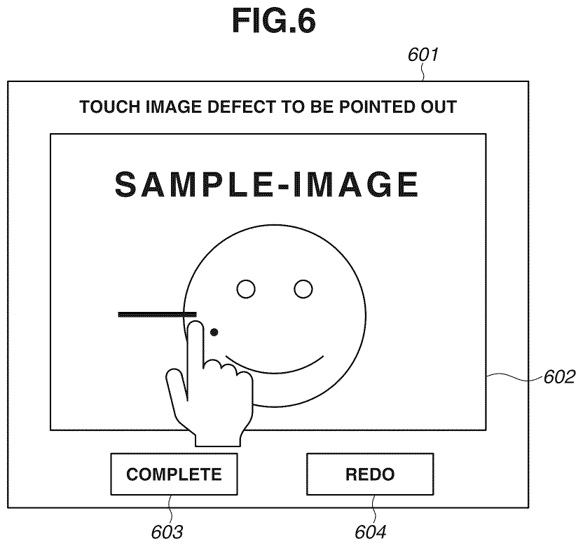

FIG. 6 illustrates a display example of the position input screen 601 for the user to input the image defect position determined by the user with a one-point touch operation on the screen in step S304. The image defect position input screen 601 includes a preview screen 602 in which the user image data 401 is previewed, a complete button 603, and a redo button 604. When the user inputs the image defect position with a one-point touch operation, a red cross mark appears at the input coordinate position so that the user can recognize the position. The mark appearing at the input coordinate position specified with a one-point touch operation by the user is not limited to a red cross. Any format of the mark that enables the user to recognize the input coordinate position may be used. The complete button 603 remains unselectable until the user inputs an image defect position with a one-point touch operation, and the complete button 603 is made selectable after the user inputs an image defect position with a one-point touch operation. When the complete button 603 is selected, the CPU 201 determines the input coordinate position to be the image defect position intended to be pointed out by the user and stores the input coordinate position in the storage device 208. The redo button 604 remains unselectable until the user inputs an image defect position with a one-point touch operation and is made selectable when the user inputs an image defect position with a one-point touch operation. When the redo button 604 is selected, the mark of the red cross indicating the input coordinate position on the preview screen 602 disappears, allowing the user to input an image defect position with a one-point touch operation again. The complete button 603 and the redo button 604 may be initially displayed in a grayed-out manner and then, after the user inputs an image defect position, the complete button 603 and the redo button 604 may be made capable of receiving the user input.

In step S305, the CPU 201 performs processing for identifying a candidate for an image defect specified by the user from among the detection image defects based on the result of the image defect detection acquired in step S303 and the input coordinates received from the user in step S304. More specifically, the CPU 201 identifies a candidate that is located near the input coordinates specified by the user and has a high confidence of being an image defect from among the image defect candidates (FIG. 5) detected by the image diagnostic apparatus 103.

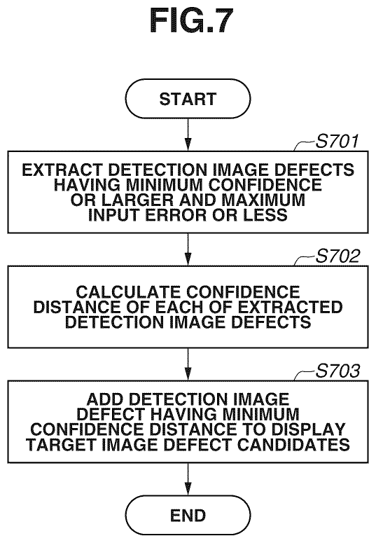

FIG. 7 is a flowchart illustrating details of processing to identify an image defect candidate in step S305 according to the present exemplary embodiment. In identifying an image defect candidate, there may arise an error between the image defect that the user has intended to specify on the preview screen 602 displaying the user image data and the input coordinates actually specified by the user with a one-point touch operation (hereinafter, such an error is also referred to as an input error). Thus, the input coordinates received in step S304 may fall outside any of the candidate regions for the plurality of image defects (bounding boxes 412 to 414 in FIG. 4A) detected by the image diagnostic apparatus 103. Meanwhile, if an image defect candidate detected by the image diagnostic apparatus 103 is present near the input coordinates specified by the user, the image defect candidate is highly likely to be the image defect intended to be specified by the user. However, if a plurality of image defect candidates detected by the image diagnostic apparatus 103 is present near the input coordinates specified by the user, the CPU 201 needs to determine which one of the plurality of candidates is the image defect having been specified by the user. Thus, according to the present exemplary embodiment, the CPU 201 identifies the candidate region for the image defect that the user has intended to specify using the input error between each of the plurality of image defect candidates detected by the image diagnostic apparatus 103 and the input coordinates received in step S304, and the confidence for each corresponding one of the plurality of detected image defect candidates. In the exemplary embodiment, the input error refers to the shortest distance between the bounding box indicating the candidate region for an image defect and the input coordinates, but the present disclosure is not limited thereto. For example, the input error may be the distance between the center of gravity of a bounding box and the input coordinates. If the input coordinates are located within a bounding box, the input error is set to zero. An image defect candidate region at a position considerably away from the input coordinates is presumably not the image defect that the user has intended to specify. Thus, image defect candidates present within a predetermined range from the input coordinates may be set as determination targets. In the following descriptions, this predetermined range is referred to as a maximum input error. The maximum input error may be a default value preset in the image forming apparatus 102 or a value set by the user.

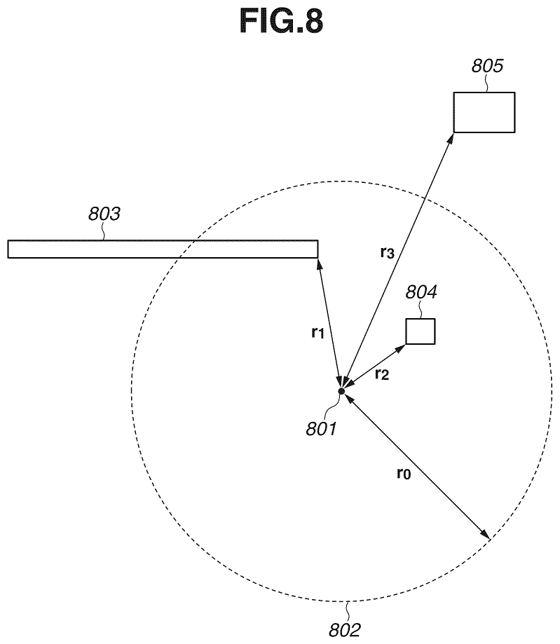

FIG. 8 illustrates an example of the relation between the input coordinates and the input error in the present exemplary embodiment. Input coordinates 801 are input with a one-point touch operation by the user. A circle 802 indicates a range with the input coordinates 801 as the center and a maximum input error r0 as the radius. Assume that the distance (i.e., input error) between each of bounding boxes 803, 804, and 805 indicating the positions of the image defect candidates detected by the image diagnostic apparatus 103 and the input coordinates 801 is r1, r2, and r3, respectively. Referring to FIG. 8, the input error between each bounding box and the input coordinates is the shortest distance between the corresponding bounding box and the input coordinates. Referring to FIG. 8, the relation between the four different distances is r2<r1<r0<r3. More specifically, referring to FIG. 8, the input errors of the bounding boxes 803 and 804 are less than the maximum input error r0, and the input error of the bounding box 805 is larger than the maximum input error r0. In this case, the bounding box 805 at a position further than the maximum input error r0 is regarded as not the image defect that the user has intended to specify.

Even if the input coordinates are present within the bounding box indicating the position of the image defect candidate detected by the image diagnostic apparatus 103, the detection image defect is not likely to be the image defect that the user has intended to specify if the confidence of the image defect candidate indicated by the bounding box being an image defect is low. Thus, in the present exemplary embodiment, the image defect candidates, detected by the image diagnostic apparatus 103, with a confidence greater than or equal to a predetermined minimum confidence, are set to determination targets, while those with a confidence below the predetermined minimum confidence are excluded from the determination targets. The predetermined minimum confidence may be a default value preset in the image forming apparatus 102 or a value set by the user.

In step S701, the CPU 201 extracts all detection image defects having a confidence equal to or greater than the minimum confidence and an input error equal to or less than the maximum input error r0 from among the detection image defects detected by the image diagnostic apparatus 103 and sets the extracted detection image defects to be processing targets for the operations in steps S702 and S703. The CPU 201 stores the extracted detection image defects in the storage device 208.

In step S702, the CPU 201 calculates a confidence distance R as an index for determining whether each of the detection image defects determined to be processing targets in step S701 is the image defect that the user has intended to specify. In the present exemplary embodiment, the CPU 201 performs the evaluation in consideration of both the confidence for each detected image defect and its input error. For example, the confidence distance R is obtained by the following Equation 1 where p denotes the confidence, r denotes the input error, and a denotes a predetermined constant. The unit of the input error may be the number of pixels and can be calculated by using the Pythagorean proposition. The confidence distance R, represented by the following Equation 1, indicates that the smaller the value thereof, the higher the likelihood that a corresponding detection image defect is the image defect that the user has intended to specify.

$$R = \frac{r + a}{p} \qquad [ Equation l ]$$

The constant a is obtained by the following Equation (2) where p0 denotes the minimum confidence and r0 denotes the maximum input error r0.

$$a = \frac{{p}_{0} {r}_{0}}{1 - {p}_{0}} \qquad [ Equation 2 ]$$

In the present exemplary embodiment, the above-described confidence distance R represents an index for determining which of the plurality of detection image defects detected by the image diagnostic apparatus 103 is the image defect that the user has intended to specify. However, other determination indices may also be used.

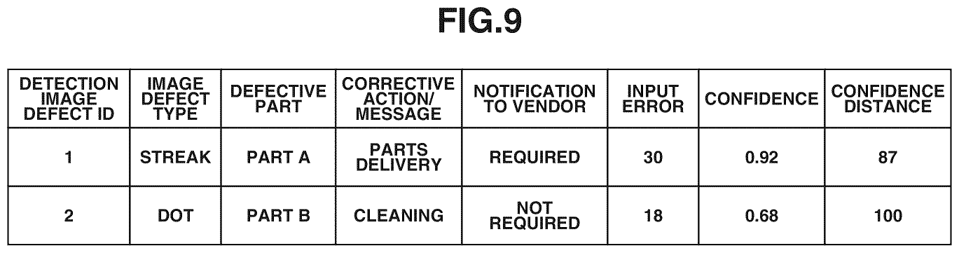

FIG. 9 illustrates an example of a result of the confidence distance calculation when the CPU 201 performs the operations in steps S701 to S702 on the image defect detection results in FIG. 5, with a minimum confidence of 0.5 and a maximum input error of 50 pixels. In step S701, the CPU 201 obtains the distance (input error) between each of the image defects with the detection image defect IDs 1 to 3 and the input coordinates and determines the image defects with the detection image defect IDs 1 and 2, which have an input error of 50 or less and a confidence of 0.5 or greater, to be processing targets for step S702. In step S702, the CPU 201 calculates the confidence distance for each detection image defect determined to be processing targets and obtains the results as illustrated in FIG. 9. FIG. 9 illustrates the information about the image defects with the detection image defect IDs 1 and 2 in FIG. 5 with additional information regarding the input error obtained in step S701 and the confidence distance calculated in step S702. The information about the X and Y coordinates, width, and height in FIG. 5 are omitted.

In step S703, based on the result of the confidence distance calculation performed in step S702, the CPU 201 adds the detection image defect having the lowest confidence distance to a plurality of display target image defect candidates. The CPU 201 stores the plurality of display target image defect candidates in the storage device 208. If the confidence distance of the detection image defect having the lowest confidence distance is close in value to the confidence distance of the detection image defect having the second lowest confidence distance, the CPU 201 may add both detection image defects to the plurality of display target image defect candidates. For example, the CPU 201 may add all the detection image defects having a confidence distance equal to or less than the lowest confidence distance times 1.05 to the plurality of display target image defect candidates.

In step S306, the CPU 201 determines whether there is at least one display target image defect candidate determined in step S305 (steps S701 to S703). If the CPU 201 determines that there is at least one display target image defect candidate (YES in step S306), the processing proceeds to step S307. If the CPU 201 determines that there is no display target image defect candidate (NO in step S306), the processing proceeds to step S312.

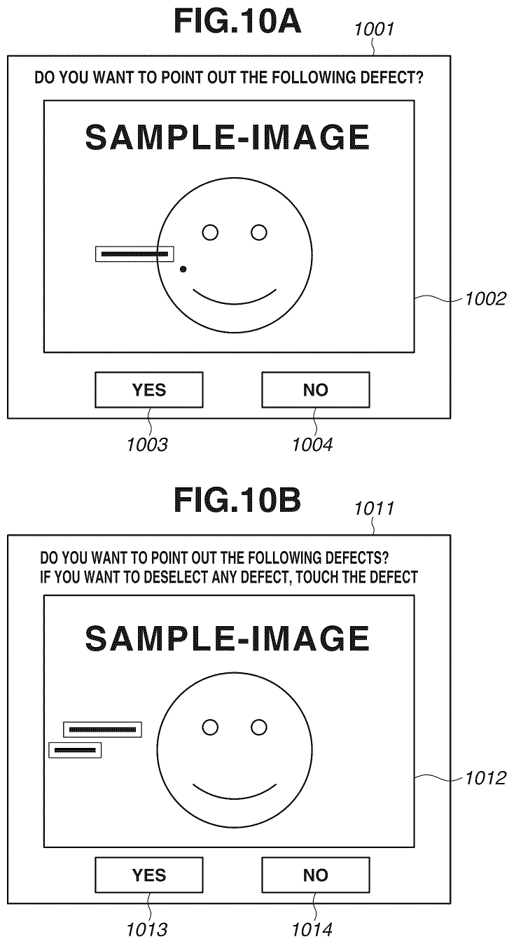

In step S307, the CPU 201 displays a check screen 1001 including the position of the display target image defect candidate on the operation panel 207 and prompts the user for confirmation. FIG. 10A illustrates an example of the check screen 1001 displayed in step S307. The check screen 1001 includes a region check screen 1002, a YES button 1003, and a NO button 1004. In the region check screen 1002, the bounding box indicating the position of a display target image defect candidate overlaid on the user image data 401 is displayed. When the YES button 1003 is selected, the display target image defect candidate corresponding to the bounding box currently displayed is determined to be the image defect that the user has intended to specify, and the data of this display target image defect candidate is stored in the storage device 208. In the following descriptions, the detection image defect determined to be the image defect that the user has intended to specify is referred to as a confirmed image defect. When the NO button 1004 is selected, the CPU 201 determines that the display target image defect candidate is not the image defect that the user has intended to specify.

In a case where the CPU 201 determines that there is a plurality of display target image defect candidates (YES in step S306), the processing proceeds to step S307. In step S307, the CPU 201 displays the positions of all the display target image defect candidates on the check screen 1002. However, the image defect that the user has intended to specify is not necessarily all of them. Thus, the user may exclude any unintended image defect out of the plurality of image defect candidates displayed in step S307, from the processing targets. FIG. 10B illustrates an example of a check screen 1011 for presenting the plurality of display target image defect candidates to the user and prompting the user to check the selection in step S307. The check screen 1011 includes a region check screen 1012, a YES button 1013, and a NO button 1014. The region check screen 1012 displays the bounding boxes that indicate the positions of the plurality of display target image defect candidates determined in step S305, which are superimposed on the user image data. If the user performs, for example, a one-point touch operation on a bounding box indicating a position of a display target image defect candidate determined to be not an image defect from among the displayed bounding boxes, the bounding box is displayed with its outline in a lighter color to indicate that the bounding box has been excluded from the processing targets by the user. If the user again performs, for example, a one-point touch operation on the bounding box with a lighter outline color, indicating exclusion from the processing targets, the outline color of the bounding box may be restored to its original color to indicate that the bounding box has been included back into the processing targets. In the above-described example, the outline color of a bounding box is changed in response to the user's one-point touch operation on the check screen 1012. However, the change object is not limited to the outline color of a bounding box, and it is sufficient if it is recognizable that the target bounding box has been selected as a processing target or not. For example, when a bounding box is to be excluded from the processing targets, the outline of the bounding box may change to a dotted line. When the user selects the YES button 1013 in the check screen 1011 in FIG. 10B, the CPU 201 determines each detection image defect corresponding to a bounding box selected as a processing target in the region check screen 1012 to be a confirmed image defect. The CPU 201 stores the data of each confirmed image defect in the storage device 208. When the user selects the NO button 1014, the CPU 201 determines the plurality of display target image defect candidates to be not image defects that the user has intended to specify.

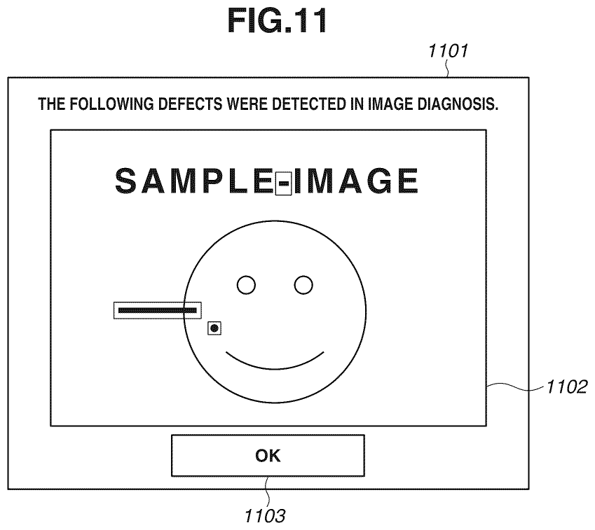

In the example in FIG. 10A, the display target image defect candidates identified in step S305 are displayed. However, a button (not illustrated) for checking all the results of the image defect detection by the image diagnostic apparatus 103 may be separately provided in the check screen 1001 in FIG. 10A. When the user operates the button, the CPU 201 displays the check screen 1101 in which the user can check all the detection image defects that have been detected by and acquired from the image diagnostic apparatus 103 in step S303, as illustrated in FIG. 11. The check screen 1101 includes a detection image defect display screen 1102 and an OK button 1103. In the detection image defect display screen 1102, the bounding boxes indicating the positions of the detection image defects detected by the image diagnostic apparatus 103 are displayed combined with the user image data 401. When the OK button 1103 is selected, the CPU 201 ends the display of the detection image defect check screen 1101 in FIG. 11.

In step S308, the CPU 201 determines whether a confirmed image defect is stored in the storage device 208 as a result of checking in step S307. If the CPU 201 determines that there is a confirmed image defect (YES in step S308), the processing proceeds to step S309. If the CPU 201 determines that there is no confirmed image defect (NO in step S308), the processing proceeds to step S312.

In step S309, the CPU 201 acquires information about the corrective action and message for the confirmed image defect with reference to the table as illustrated in FIG. 9 and displays an image diagnosis result screen. It is sufficient for the image diagnosis result screen to allow the user to recognize the measures to be taken based on the image diagnosis result.

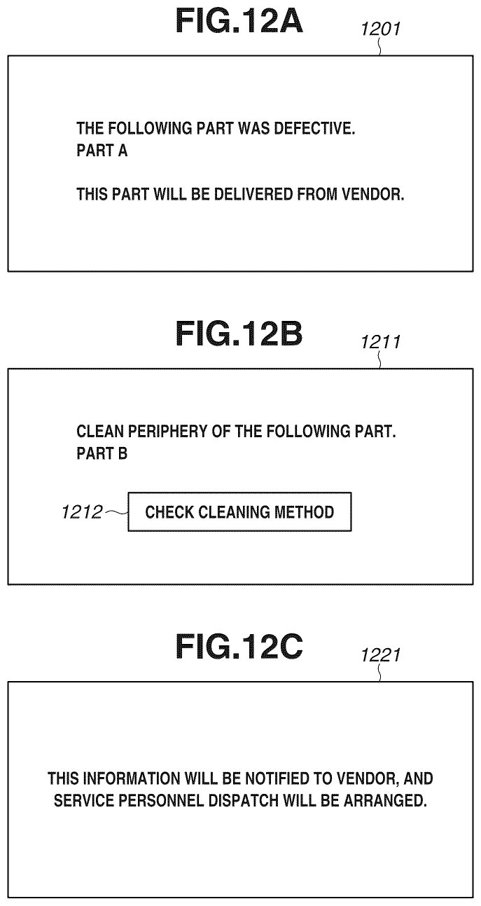

For example, if the corrective action for the confirmed image defect is parts delivery, the CPU 201 displays an image diagnosis result screen 1201 to notify the user of replacement part delivery on the operation panel 207, as illustrated in FIG. 12A. For example, the image diagnosis result screen 1201 displays the name of the part determined to be replaced through image diagnosis and a message notifying that the part will be delivered from the vendor.

If the corrective action for the confirmed image defect is cleaning, the CPU 201 displays an image diagnosis result screen 1211 to notify the user of the cleaning position and cleaning procedure on the operation panel 207, as illustrated in FIG. 12B. For example, the image diagnosis result screen 1211 displays the cleaning position that has been determined to require cleaning through image diagnosis and a Check Cleaning Method button 1212. When the Check Cleaning Method button 1212 is selected, the CPU 201 displays the cleaning method for the cleaning position that has been determined to require cleaning through image diagnosis. The image diagnosis result screen 1211 may display a message regarding the cleaning method instead of the Check Cleaning Method button 1212 or display the Uniform Resource Locator (URL) of the home page where the cleaning method can be viewed.

In step S310, the CPU 201 determines whether the vendor needs to be notified of the image diagnosis result regarding the confirmed image defect, with reference to the table as illustrated in FIG. 9. For example, if the image defect with the detection image defect ID 2 in FIG. 9 is a confirmed image defect, the corrective action is cleaning by the user, and notification to the vendor is determined to be not required. Thus, in this case, the CPU 201 determine that the transmission of the image diagnosis result to the vendor is not required, and the processing is ended. In a case where an image defect with the detection image defect ID 1 in FIG. 9 is a confirmed image defect, the corrective action is parts delivery. Since parts delivery from the vendor is required, it is determined that notification to the vendor is required. Thus, in this case, the CPU 201 determines that the transmission of the image diagnosis result to the vendor is required, and the processing proceeds to step S311.

In step S311, the CPU 201 transmits the image diagnosis result (e.g., information about a defective part and corrective action) to the management server 104 managed by the vendor, via the network interface card 205. In one embodiment, the CPU 201 transmits the user image data in addition to information about the confirmed image defect (e.g., information about the defective part, necessity of parts delivery, necessity of arranging service personnel's visit to the user's location) as the image diagnosis result.

In step S312, the CPU 201 displays an image diagnosis result screen 1221 as illustrated in FIG. 12C on the operation panel 207. The image diagnosis result screen 1221 includes messages regarding the notification of the occurrence of an image defect to the vendor and the arrangement of the visit to or contact with the user location from the vendor.

In step S313, the CPU 201 transmits information about the occurrence of an image defect to the management server 104 of the vendor via the network interface card 205. In notifying the vendor of the occurrence of an image defect, in one embodiment, the CPU 201 transmits the user image data and information about the input coordinates input by the user in step S304 to the management server 104 of the vendor to allow the vendor to preview the image data having the image defect.

The present exemplary embodiment provides for image diagnosis without printing a test pattern.

Even if the user does not precisely specify the region where an image defect occurs, the CPU 201 can identify the image defect that the user has intended to specify, based on the region determined to be an image defect candidate by the image diagnostic apparatus 103. Particularly, the user does not need to precisely specify the position of the image defect region on the small-sized operation panel 207 of the image forming apparatus 102. If the corrective action for an image defect is replacement part delivery or part cleaning by the user, it is sufficient to display a message thereof on the screen, thus reducing the cost of dispatching service personnel of the vendor to the user location.

In the above-described example, when the user inputs an image defect position with a one-point touch operation in step S304 in FIG. 3, the CPU 201 receives the input coordinates. The reception of the input coordinates is not limited to one position. If image defects occur at a plurality of positions on the scan image, inputs of the plurality of positions may be received from the user. If inputs of image defects at a plurality of positions are received, the operation in step S305 (steps S701 to S703) may be performed on each of the plurality of input coordinates.

According to the above-described exemplary embodiment, input coordinates through a touch operation are received from the user. However, the input method is not limited to a touch operation. The CPU 201 may receive input coordinates through an operation via a pointing device such as a mouse.

A second exemplary embodiment of the present disclosure will be described below. According to the first exemplary embodiment, if an image defect occurs in the image forming apparatus 102, the CPU 201 calculates the confidence distance for a detection image defect in step S702 and adds the detection image defect having the lowest confidence distance to a plurality of display target image defect candidates in step S703. However, image defects resulting from an identical cause (e.g., streaky image defects) may appear side-by-side at very close positions on a print product. Thus, according to the second exemplary embodiment, the CPU 201 performs processing to collectively add these image defects to the plurality of display target image defect candidates.

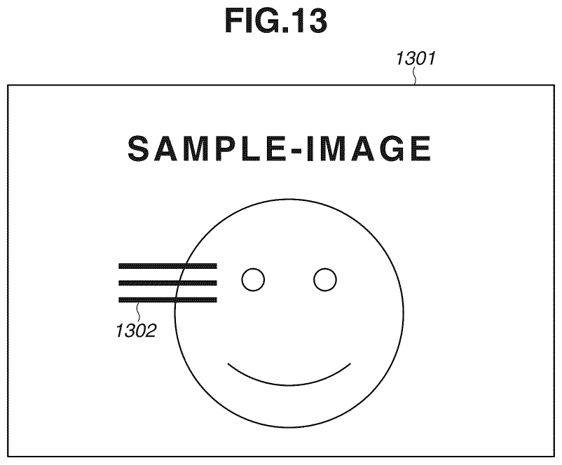

FIG. 13 illustrates an example of a user print product 1301 in which streaks of image defects resulting from an identical cause appear side-by-side at very close positions. An image defect 1302 indicates streaks of image defects resulting from an identical cause appearing side-by-side at very close positions.

According to the first exemplary embodiment, the CPU 201 adds only the detection image defect having the lowest confidence distance out of a plurality of detection image defects to the plurality of display target image defect candidates in step S703. In the second exemplary embodiment, a description will be provided of a configuration for grouping the detection image defect having the lowest confidence distance and detection image defects, from a plurality of detection image defects, that are present in the vicinity and determined to be caused by the same defective part and adding this group of detection image defects to the plurality of display target image defect candidates. More specifically, the second exemplary embodiment differs from the first exemplary embodiment in the operation in step S305 (the operation for identifying which of the detection image defects detected by the image diagnostic apparatus 103 corresponds to the image defect that the user has intended to specify).

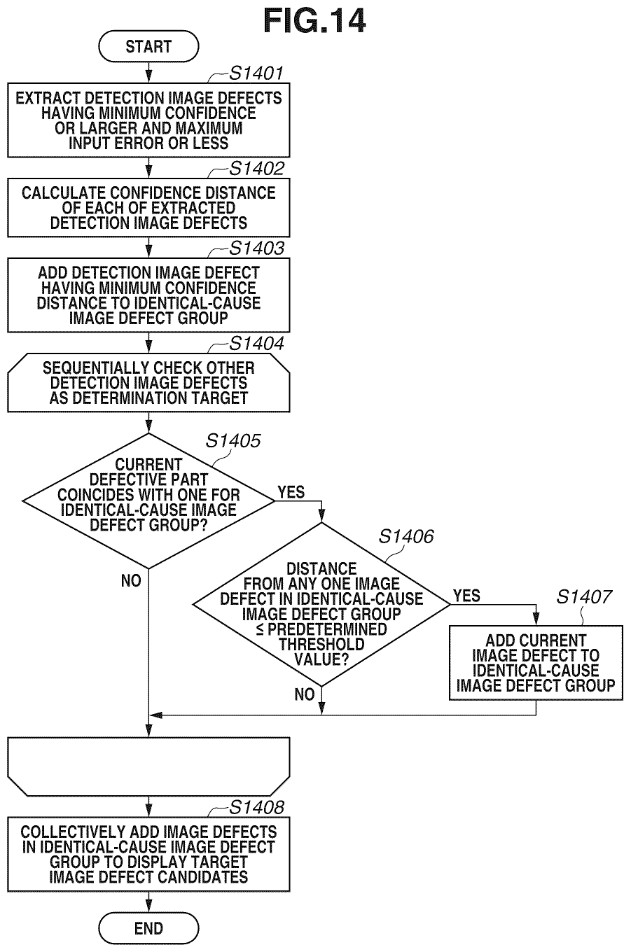

FIG. 14 is a flowchart illustrating details of the operation in step S305 according to the second exemplary embodiment.

In step S1401, the CPU 201 extracts all the detection image defects having a confidence equal to or larger than the minimum confidence and an input error equal to or less than the maximum input error from among the detection image defects detected by the image diagnostic apparatus 103 and sets the extracted detection image defects to be processing targets for the operation in step S1402. The CPU 201 stores the extracted detection image defects in the storage device 208.

In step S1402, the CPU 201 calculates the confidence distance as an index for determining whether each of the detection image defects determined to be a processing target for the operation in step S1401 is the image defect that the user has intended to specify. The operations in steps S1401 to S1402 may be similar to those in steps S701 to S702 in the first exemplary embodiment.

In step S1403, based on the result of the confidence distance calculation, the CPU 201 adds the detection image defect having the lowest confidence distance to a new group for identifying a group of image defects resulting from an identical cause (this group is referred to as an identical-cause image defect group). More specifically, the CPU 201 may add information about the detection image defect having the lowest confidence distance to a buffer for collectively managing the identical-cause image defect group in the storage device 208. It is sufficient that a group to be collectively displayed can be identified. The management method is not limited to the method of adding detection image defects to a buffer for group identification. For example, the CPU 201 may assign a group identifier for group identification to an individual detection image defect to manage the identical-cause image defect group. In this case, a new group identifier may be assigned to the detection image defect having the lowest confidence distance. To exclude the detection image defects having been added to the identical-cause image defect group from the processing targets for steps S1404 to S1407, the detection image defects having been added to the identical-cause image defect group may be excluded from the detection image defects detected by the image diagnostic apparatus 103.

Step S1404 is the start of the loop for performing the operations in steps S1405 and S1407 with the detection image defects other than the detection image defect having the lowest confidence distance sequentially set to the determination target. In step S1404, it is desirable that the CPU 201 sequentially set the detection image defects to determination targets in ascending order of each detection image defect's distance from the detection image defects having been added to the identical-cause image defect group.

In step S1405, the CPU 201 determines whether the defective part diagnosed for the detection image defect set to the current determination target is the same as the defective part diagnosed for any one detection image defect having been added to the identical-cause image defect group. More specifically, based on the result of the image defect detection by the image diagnostic apparatus 103 as illustrated in FIG. 5, the CPU 201 determines whether the defective part diagnosed for the detection image defect set to the current determination target is the same as the defective part diagnosed for the detection image defect determined to have the lowest confidence distance in step S1403. If the CPU 201 determines that the defective part causing the detection image defect set to the current determination target is the same as the defective part causing the detection image defects having been added to the identical-cause image defect group (YES in step S1405), the processing proceeds to step S1406. If the CPU 201 determines that the defective part causing the detection image defect set to the current determination target is not the same as the defective part causing the detection image defects having been added to the identical-cause image defect group (NO in step S1405), the CPU 201 performs processing for the start of the loop in step S1404. If any detection image defect remains unprocessed as a determination target, the processing returns to step S1405 for the detection image defect as the next determination target.

In step S1406, the CPU 201 determines whether the distance between the detection image defect set to the current determination target and one of the detection image defects having been added to the identical-cause image defect group is equal to or less than a predetermined threshold value. If the CPU 201 determines that the distance between the detection image defect set to the current determination target and one of the detection image defects having been added to the identical-cause image defect group is equal to or less than the predetermined threshold value (YES in step S1406), the processing proceeds to step S1407. If the CPU 201 determines that the distance between the detection image defect set to the current determination target and one of the detection image defects having been added to the identical-cause image defect group is greater than the predetermined threshold value (NO in step S1406), the CPU 201 performs processing for the start of the loop in step S1404. If any detection image defect remains unprocessed as a determination target, the processing returns to step S1405 with the detection image defect serving as the next determination target. The predetermined threshold value may be a default value preset in the image forming apparatus 102 or a value set by the user.

In step S1407, the CPU 201 adds the detection image defect set to the current determination target to the identical-cause image defect group. Subsequently, through the end of the loop paired with the start of the loop in step S1404, if any detection image defect remains unprocessed as a determination target, the processing returns to step S1405 with the detection image defect set to the next determination target.

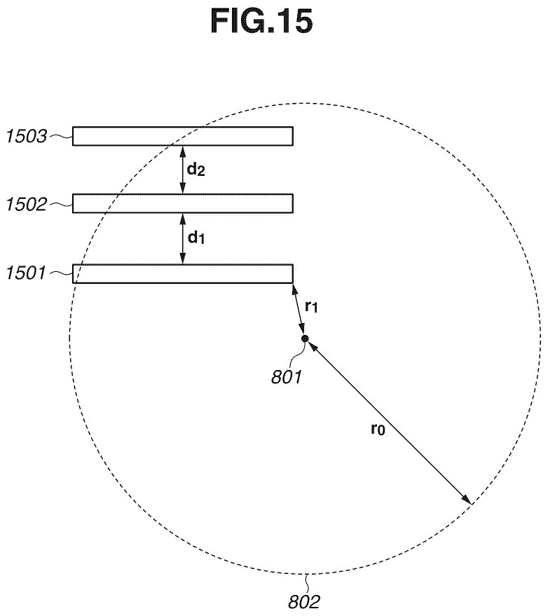

FIG. 15 illustrates an example of the operations in steps S1404 to S1407. In this example, the image defect 1302 having three different streaks has been detected by the image diagnostic apparatus 103 analyzing a scan image of a user print product as illustrated in FIG. 13. Further, in the example, the user has input the input coordinates 801 in the vicinity of bounding boxes 1501 to 1503 corresponding to the detection image defect 1302 detected in step S304. A circle 802 indicates a range of the maximum input error r0 from the input coordinates 801. The bounding box 1501 has a distance r1 from the input coordinates 801 (input error r1). The bounding box 1501 has been added to the identical-cause image defect group as the detection image defect having the lowest confidence distance from the input coordinates 801 in step S1403. The distance between the bounding boxes 1501 and 1502 is d1, and the distance between the bounding boxes 1502 and 1503 is d2. The detection image defects corresponding to the bounding boxes 1501, 1502, and 1503 are image defects resulting from an identical cause and have been diagnosed as having been caused by the same defective part by the image diagnostic apparatus 103. Referring to FIG. 15, the relation of magnitude between the distances r0 and r1 is assumed to be r1<r0. When a predetermined threshold value do is used in the determination processing in step S1406, the distances d1 and d2 are equal to or less than do.

The bounding box 1502 is the one that has the lowest distance from the image defect (the detection image defect corresponding to the bounding box 1501) having been added to the identical-cause image defect group. In step S1404, the CPU 201 acquires information about the detection image defect corresponding to the bounding box 1502 as the current determination target. In step S1405, the CPU 201 compares the defective part as the cause of the detection image defect corresponding to the bounding box 1502 with the defective part as the cause of the defect image having been added to the identical-cause image defect group. Since the defective part causing the detection image defect corresponding to the bounding box 1502 coincides with the defective part causing the defect image (the detection image defect corresponding to the bounding box 1501) having been added to the identical-cause image defect group, the processing proceeds to step S1406. In step S1406, the CPU 201 compares the distance d1 between the detection image defect corresponding to the bounding box 1502 and the image defect having been added to the identical-cause image defect group with the predetermined threshold value d0. Referring to the example in FIG. 15, because the distance d1 is equal to or less than the distance d0, the processing proceeds to step S1407. In step S1407, the CPU 201 adds the detection image defect corresponding to the bounding box 1502 to the identical-cause image defect group.

Through the operation of the start of the loop in step S1404, the bounding box 1503 having the lowest distance from the identical-cause image defect group (the detection image defects corresponding to the bounding boxes 1501 and 1502) is set to the next determination target and the CPU 201 acquires information about the detection image defect corresponding to the bounding box 1503. Then, the processing proceeds to step S1405. In step S1405, the CPU 201 compares the defective part causing the detection image defect corresponding to the bounding box 1503 with the defective part causing the image defects having been added to the identical-cause image defect group. Since the defective part causing the detection image defect corresponding to bounding box 1503 coincides with the defective part causing the image defects (the detection image defects corresponding to the bounding boxes 1501 and 1502) having been added to the identical-cause image defect group, the processing proceeds to step S1406. In step S1406, the CPU 201 compares the distance d2 between the detection image defect corresponding to bounding box 1503 and the image defect having been added to the identical-cause image defect group with the predetermined threshold value do. Referring to the example in FIG. 15, because the distance d2 is equal to or less than the distance d0, the processing proceeds to step S1407. In step S1407, the CPU 201 adds the detection image defect corresponding to the bounding box 1503 to the identical-cause image defect group.

In step S1408, the CPU 201 collectively adds the detection image defects having been added to the identical-cause image defect group to the plurality of display target image defect candidates. The CPU 201 stores the plurality of display target image defect candidates in the storage device 208. In the example in FIG. 15, the detection image defects corresponding to the bounding boxes 1501 to 1503 are collectively stored as display target image defect candidates. Thus, in the example in FIG. 15, the CPU 201 determines that at least one display target image defect candidate is present in step S306 and displays the regions of the bounding boxes 1501 to 1503 overlaid on the user image data in step S307.

As described above, simply by specifying coordinates with an on-screen one-point touch operation on a user image where a plurality of image defects resulting from an identical cause appears at close positions, the CPU 201 can collectively identifiably display the plurality of image defects as the image defects having been specified by the user.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-096379, filed Jun. 14, 2024, the entirety of which is incorporated herein by reference.

What is claimed is:

1. An image forming apparatus comprising:
an operation panel having a display screen,
one or more memories storing one or more instructions, and
one or more processors that, upon execution of the stored one or more instructions, cause the image forming apparatus to:
display an image obtained by scanning a print product on the display screen of the operation panel;
receive information about a position in the image specified by a user via the display screen of the operation panel;
identify at least one image defect candidate region obtained through analysis of the image as a region of an image defect corresponding to the position specified by the user, based on image defect candidate region position information, image defect candidate region confidence, and information about the position specified by the user; and
display information corresponding to the at least one image defect candidate region identified on the display screen of the operation panel.

2. The image forming apparatus according to claim 1, wherein the image defect candidate region confidence indicates a degree of certainty that an image defect occurs in the corresponding image defect candidate region.

3. The image forming apparatus according to claim 1, wherein an image diagnostic apparatus different from the image forming apparatus analyzes the image to obtain the at least one image defect candidate region and its corresponding image defect candidate region confidence.

4. The image forming apparatus according to claim 1, wherein the displayed information corresponding to the at least one image defect candidate region identified comprises the position of the at least one image defect candidate region identified overlaid on the image.

5. The image forming apparatus according to claim 1, wherein the displayed information corresponding to the at least one image defect candidate region identified comprises information about corrective action to be taken for an image defect occurring in the at least one image defect candidate region identified.

6. The image forming apparatus according to claim 1, wherein the displayed information corresponding to the at least one image defect candidate region identified comprises information about a part causing an image defect occurring in the at least one image defect candidate region identified.

7. The image forming apparatus according to claim 5, wherein the information about corrective action to be taken for an image defect occurring in the at least one image defect candidate region identified comprises information about a cleaning method.

8. The image forming apparatus according to claim 1, wherein the displayed information corresponding to the at least one image defect candidate region identified comprises a message that a vendor is to be notified to take corrective action for an image defect occurring in the at least one image defect candidate region identified.

9. The image forming apparatus according to claim 8 further comprising a network interface card, wherein the one or more processors, upon execution of the stored one or more instructions, further cause the image forming apparatus to:
transmit information about an image diagnosis result regarding the at least one image defect candidate region identified to a management server of the vendor via the network interface card.

10. The image forming apparatus according to claim 1, wherein the information about a position in the image specified by the user comprises input coordinates specified with a one-point touch operation on the display screen by the user.

11. The image forming apparatus according to claim 1, wherein an image defect candidate region of a first image defect identified based on image defect candidate region position information, image defect candidate region confidence, and information about the position specified by the user and an image defect candidate region of a second image defect that are caused by an identical defective part and are located at a distance from each other equal to or less than a predetermined threshold value, are identified as image defect regions corresponding to the position specified by the user.

12. A control method in an image forming apparatus including an operation panel having a display screen, the method comprising the steps of:
displaying an image obtained by scanning a print product on the display screen of the operation panel;
receiving information about a position in the image specified by a user via the display screen of the operation panel;
identifying at least one image defect candidate region obtained through analysis of the image as a region of an image defect corresponding to the position specified by the user, based on image defect candidate region position information, image defect candidate region confidence, and information about the position specified by the user; and
displaying information corresponding to the at least one image defect candidate region identified on the display screen of the operation panel.
